(19) United States
(12) Patent Application Publication
(10) Pub. No.: US 2012/0055130 A1
(43) Pub. Date: Mar. 8, 2012

(54) LAWN MOWER AND SPREADER SYSTEM

(75) Inventors: Kenneth Au, Jefferson, WI (US); Richard J. Gilpatrick, Whitewater, WI (US); Steven C. Crouch, McFarland, WI (US)

(73) Assignee: Briggs & Stratton Corporation

(21) Appl. No.: 13/223,068

(22) Filed: Aug. 31, 2011

Related U.S. Application Data
(60) Provisional application No. 61/402,597, filed on Sep. 1, 2010.

(51) Int. Cl. A01D 34/00

(52) U.S. Cl. 56/16.8

(57) ABSTRACT

A lawn mower and spreader system includes a deck, a hopper, and a spreading element. The deck supports an engine having a power takeoff and at least partially surrounds a blade coupled to the power takeoff. The hopper is configured to support granular fertilizer. Furthermore, the hopper has a discharge chute leading to an opening in the deck. The spreading element is coupled to the power takeoff of the engine and is positioned between the deck and the blade. The spreading element includes a hub and arms that extend laterally from hub. The arms are spaced apart from one another by open slots.

### CROSS-REFERENCE TO RELATED PATENT APPLICATIONS

This application claims the benefit of U.S. Provisional Application No. 61/402,597, filed Sep. 1, 2010, which is incorporated herein by reference in its entirety.

### BACKGROUND

The present application relates generally to the field of spreader devices for use distributing fertilizer, weed-control chemicals, seeds, or other items on a lawn or field. More specifically the present application relates to a combined lawn mower and spreader system.

### SUMMARY

One embodiment of the invention relates to a lawn mower and spreader system, which includes a deck, a hopper, and a spreading element. The deck supports an engine having a power takeoff, and the deck at least partially surrounds a blade coupled to the power takeoff. The hopper is configured to support granular fertilizer and has a discharge chute leading to an opening in the deck. The spreading element is coupled to the power takeoff of the engine and is positioned between the deck and the blade. The spreading element includes a hub and arms that extend laterally from hub. The arms are spaced apart from one another by open slots.

Another embodiment of the invention relates to a lawn mower and spreader system, which includes a deck, front and rear wheels coupled to the deck, a spreading element, and a hopper positioned generally over the rear wheels. The deck has a skirt and a top, which together form a cutting chamber at least partially surrounding a blade. The top of the deck supports an engine having a power takeoff extending through the top of the deck and coupled to the blade. The spreading element is coupled to the power takeoff and positioned between the deck and the blade. The hopper is configured to support granular fertilizer and has a discharge chute leading to an opening in the deck that is positioned over the spreading element.

Yet another embodiment of the invention relates to a lawn mower and spreader system, which includes a deck, a spreading element, a hopper, and a frame supporting the hopper. The deck supports an engine having a power takeoff, and the deck at least partially surrounds a blade coupled to the power takeoff. The spreading element is coupled to the power takeoff and positioned between the deck and the blade. The hopper has a discharge chute leading to an opening in the deck that is positioned over the spreading element. The frame supporting the hopper is fastened to the deck and includes a joint configured to allow the hopper to rotate forward and rearward with respect to the deck.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is perspective view of a lawn mower according to an exemplary embodiment of the invention.

FIG. 2 is a side view of the lawn mower of FIG. 1.

FIG. 3 is a perspective view of a hopper according to an exemplary embodiment of the invention.

FIG. 4 is a perspective view of the hopper of FIG. 3 in another configuration.

FIG. 5 is a perspective view of a conduit of the hopper of FIG. 3 coupled to the lawn mower of FIG. 1.

FIG. 6 is a perspective view of a cutting chamber of the lawn mower of FIG. 1.

FIG. 7 is a perspective view of a handle of the lawn mower of FIG. 1.

FIG. 8 is a perspective view of a control lever coupled to the handle of FIG. 7.

FIG. 9 is a perspective view of an actuator connected to an agitator of a container.

FIG. 10 is a perspective view of a lawn mower according to another exemplary embodiment of the invention.

FIG. 11 is another perspective view of the lawn mower of FIG. 10.

FIG. 12 is a perspective view of the lawn mower of FIG. 10 with a sectional view of a spreader taken along line 14-14 as shown in FIG. 11.

FIG. 13 is a sectional view of the lawn mower of FIG. 10 taken along line 13-13 as shown in FIG. 15.

FIG. 14 is yet another perspective view of the lawn mower of FIG. 10.

FIG. 15 is a bottom view of the lawn mower of FIG. 10.

FIG. 16 is a perspective view of a cutting chamber of a lawn mower according to an exemplary embodiment of the invention.

FIG. 17 is a perspective view of an rotary actuator powered by the rear axle of a lawn mower according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

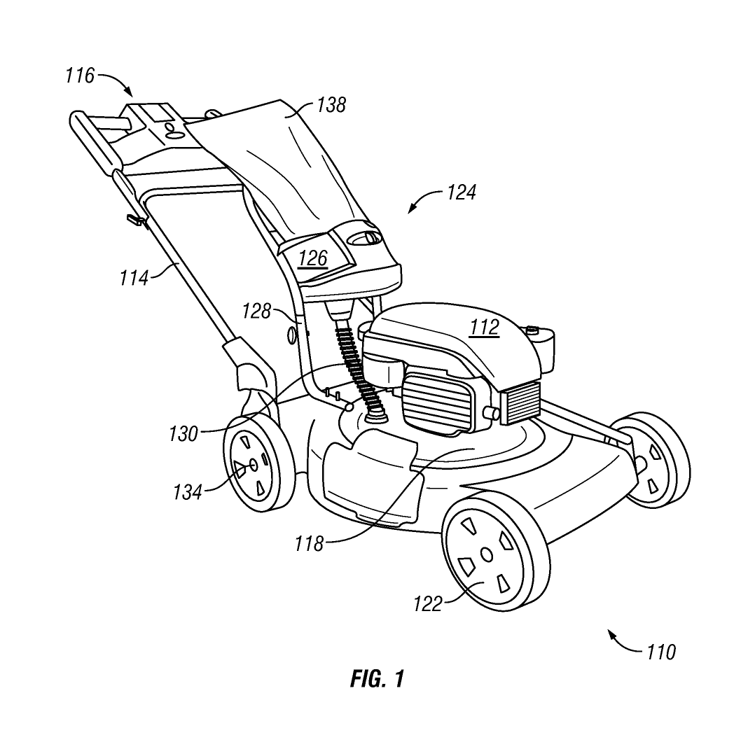

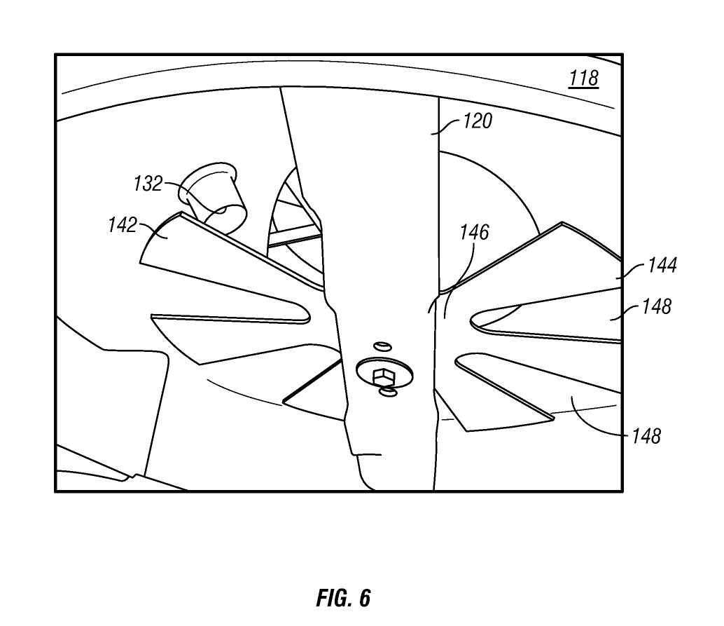

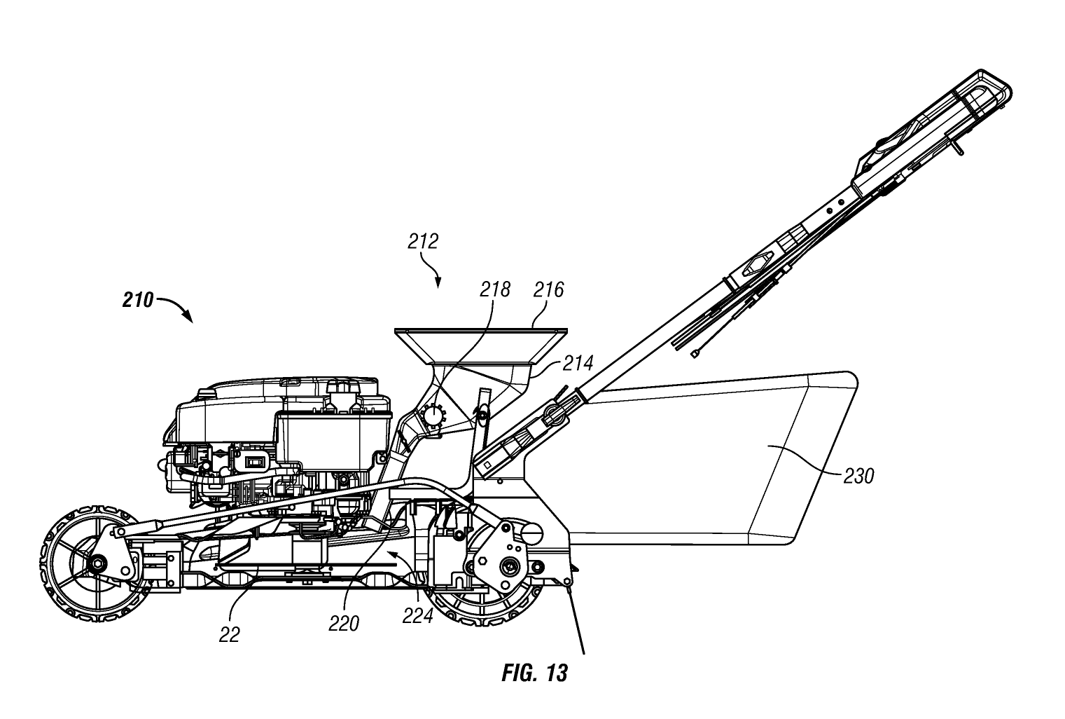

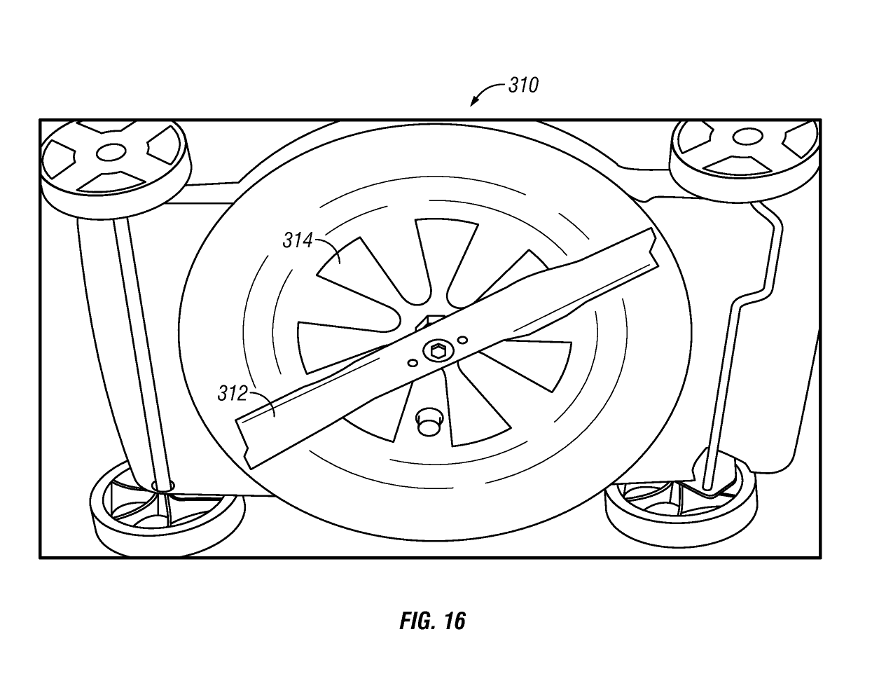

Referring to FIG. 1, a lawn mower 110 has an engine 112 fastened to a frame 114. The frame 114 includes a handle 116 extending rearward from a mowing deck 118 (e.g., platform; blade housing) to which the engine 112 is fastened. In some embodiments, the engine 112 is a small, single cylinder, four-stroke cycle, internal combustion engine. Below the engine 112, a blade (e.g., lawn mower blade, rotary blade; see, e.g., blade 120 as shown in FIG. 6) is connected to a power takeoff (see generally FIG. 13) of the engine 112. Front and rear wheels 122 are coupled to the mowing deck 118, such as by way of axles (see, e.g., fulcrum 134) that rotate within bushing connected to front and rear portions of the mowing deck 118 (see generally FIG. 16). In other embodiments, other types of engines or electric motors are used, or the equipment is powered by the operator without a motor or engine.

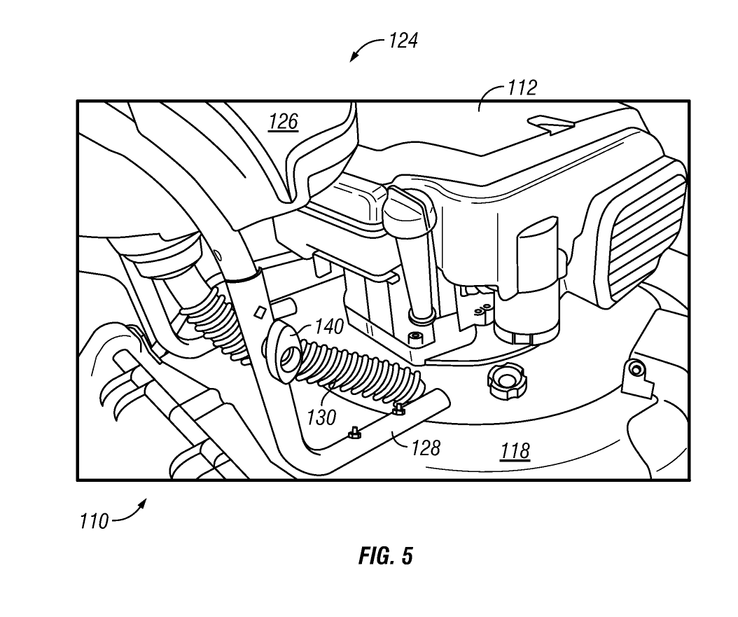

According to an exemplary embodiment, a spreader 124 (e.g., delivery device; fertilizer distributor) is coupled to the lawn mower 110 and is designed to deliver contents (e.g., granular contents; solid contents) of the spreader 124 while the lawn mower 110 is cutting grass. The spreader 124 includes a hopper 126 (e.g., container, vessel, reservoir, basin) coupled to a frame 128, which is fastened to the lawn mower 110. A conduit 130 (e.g., tube, discharge chute) extends from the hopper 126 to deliver contents of the spreader 124 to the lawn (e.g., grass). In some embodiments, the conduit 130 is coupled to the mowing deck 118 of the lawn mower 110 and directs the contents of the spreader 124 through an opening in the mowing deck 118 (see also FIG. 5 and outlet 132 as shown in FIG. 6). In other contemplated embodiments, the conduit 130 directs contents of the hopper to the front, side, and/or rear of the mowing deck. The contents of the spreader 124 may include solid or liquid contents, such as fertilizer pellets, granules, gel crystals, herbicide (e.g., week killer), pesticide, seeds, paint, or other contents.

According to an exemplary embodiment, the lawn mower 110 is a walk-behind rotary mower, as shown in FIG. 1. In other embodiments, the lawn mower may be a riding mower, an electric mower, an autonomous lawn mower, or another type of lawn mower. In still other contemplated embodiments, the other power equipment may use the spreader 124, such as a rotary tiller that tills and simultaneously delivers fertilizer or seeds, or a snow thrower that removes snow and simultaneously delivers chemicals (e.g., salt) to remove a layer of ice below the snow.

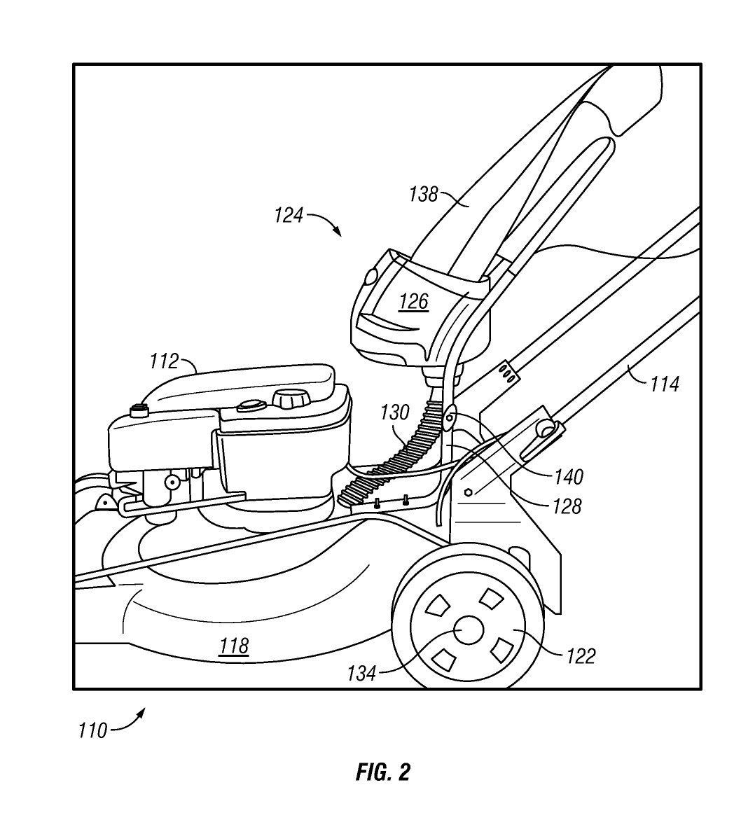

Referring to FIG. 2, the hopper 126 of the spreader 124 includes the frame 128 (e.g., support structure, housing), which is fastened to the mower deck 118. According to an exemplary embodiment, the frame 128 of the spreader 124 is substantially aligned with a fulcrum 134 of the lawn mower 110, such as vertically aligned with the wheels 122 (e.g., rear wheels). When an operator of the lawn mower 110 rotates the lawn mower 110 about the fulcrum 134 to turn the lawn mower 110, the weight of the spreader 124 (and contents thereof) does not significantly contribute to the moment required to rotate the lawn mower 110. As such, with or without the spreader 124, and with or without the spreader 124 being fully loaded, the moment required to rotate the lawn mower 110 about the fulcrum 134 is roughly the same, which is intended to provide stability when turning and ease of use (e.g., rotation about fulcrum 134). Furthermore, weight in the hopper may improve traction of embodiments that include rear-wheel drive.

According to an exemplary embodiment, the frame 128 of the spreader 124 elevates the hopper 126 above the mowing deck 118 and generally above the rear wheels 122 (see FIG. 1). Elevation of the hopper 126 allows for comfortable and quick operation of the hopper 126, such as when filling or replacing contents of the hopper 126. The operator need not bend down far to reach the hopper. Additionally, increasing the height of the hopper 126 above the mowing deck 118 (and outlet 132, as shown in FIG. 6) helps to facilitate movement of contents of the hopper 126 through the conduit 130 by providing greater potential energy to the contents of the hopper 126, which motivates the contents through the conduit 130, reducing the likelihood of clogging of the conduit 130. In other embodiments, the spreader does not include a frame that elevates the hopper. In some such embodiments, the hopper is fasted directly to the mowing deck 118.

In some contemplated embodiments, the frame 128 or the hopper 126 may be fastened to the handle 116 or another part of the frame 114, such as above the handle 116, out of the way of a grass bag (see, e.g., removable grass catch bag 230 as shown in FIG. 13). Locating the hopper 126 on the handle 116 or another part of the frame 114 may increase the height of the hopper 126 above the mowing deck 118, and the handle 116 may serve as structure to which the hopper 126 may be fastened, in place of the frame 128. In other contemplated embodiments, the frame 128 or the hopper 126 may be fastened to or in contact with the engine 112. Vibrations of the engine 112 loosen the contents of the hopper 126 (e.g., fertilizer pellets). Essentially the engine 112 serves as a vibratory plate or agitator.

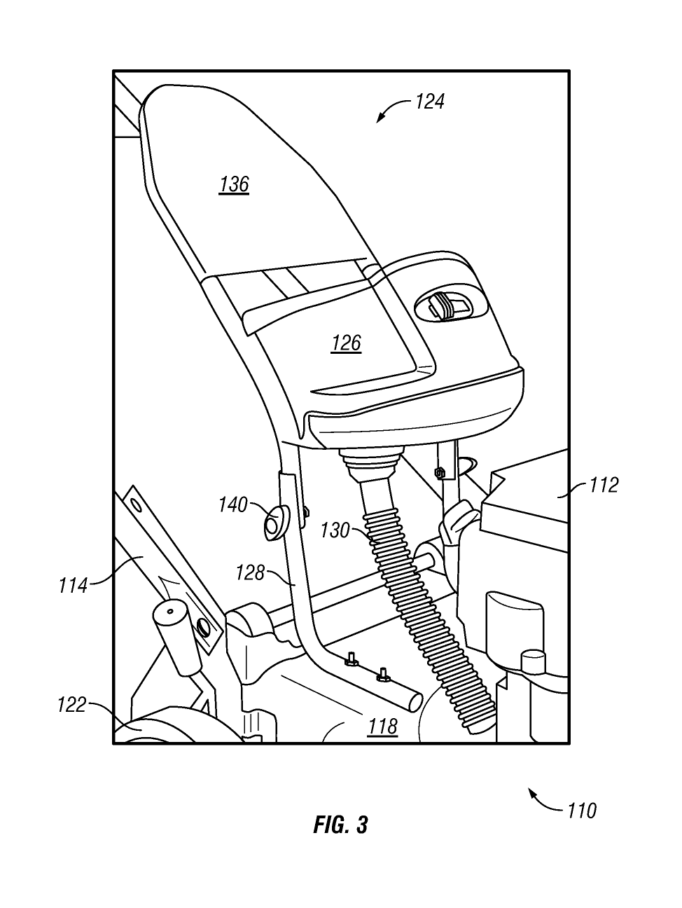

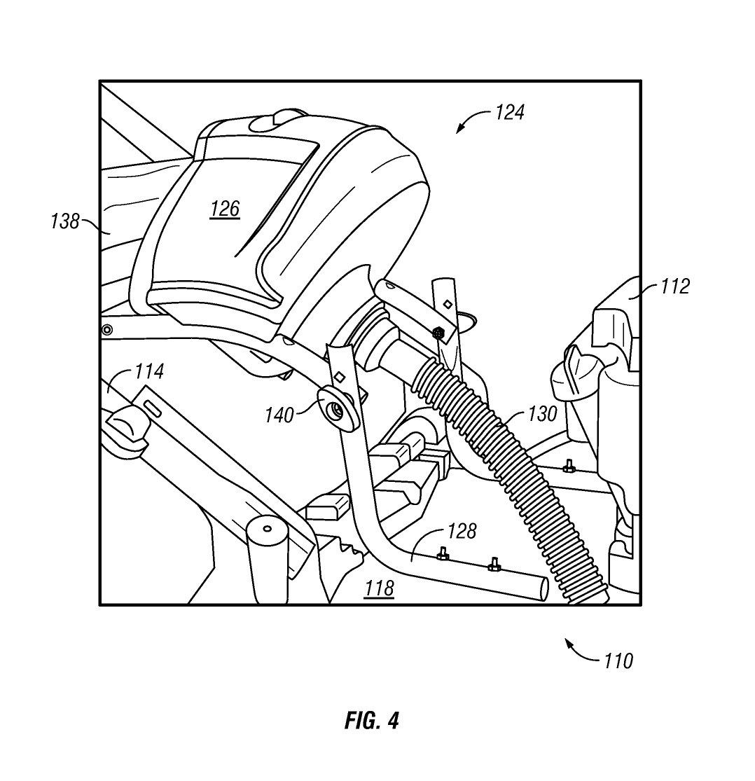

Referring to FIG. 3-4, the spreader 124 includes a support surface 136 (e.g., back rest) for a fill bag 138 (see FIG. 1) supported by a receiver (e.g., bucket) of the hopper 126. The support surface 136 and hopper 126 are angled diagonally upward and rearward (see FIG. 2) to support the fill bag 138 and facilitate efficient delivery of contents of the fill bag 138 to the hopper 126 and/or to the conduit 130. In some embodiments, an angle of about forty-five to sixty-degrees above horizontal is sufficient to move the contents of the fill bag 138 to the hopper 126 or conduit 130, without causing the contents to clump under their own weight.

According to an exemplary embodiment, as shown in FIG. 4, the frame 128 includes an adjustable pivot 140 (e.g., joint; pinned joint; single degree of freedom rotational axis) that allows the hopper 126 to be rotated backward to reduce the height of the lawn mower 110, such as when traveling under low tree branches. The adjustable pivot 140 also allows the hopper 126 to the be rotated forward to provide space proximate to the rear of the lawn mower 110, such as to allow an operator to more comfortably couple, decouple, or otherwise manipulate a grass bag to the rear of the lawn mower 110 (see, e.g., grass bag 230 as shown in FIG. 13).

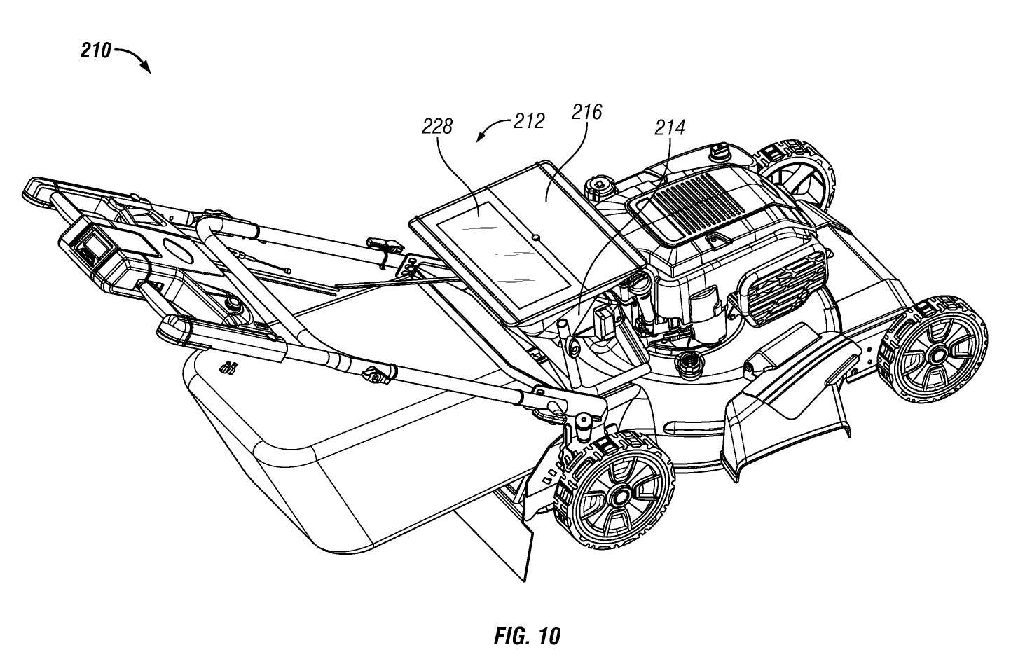

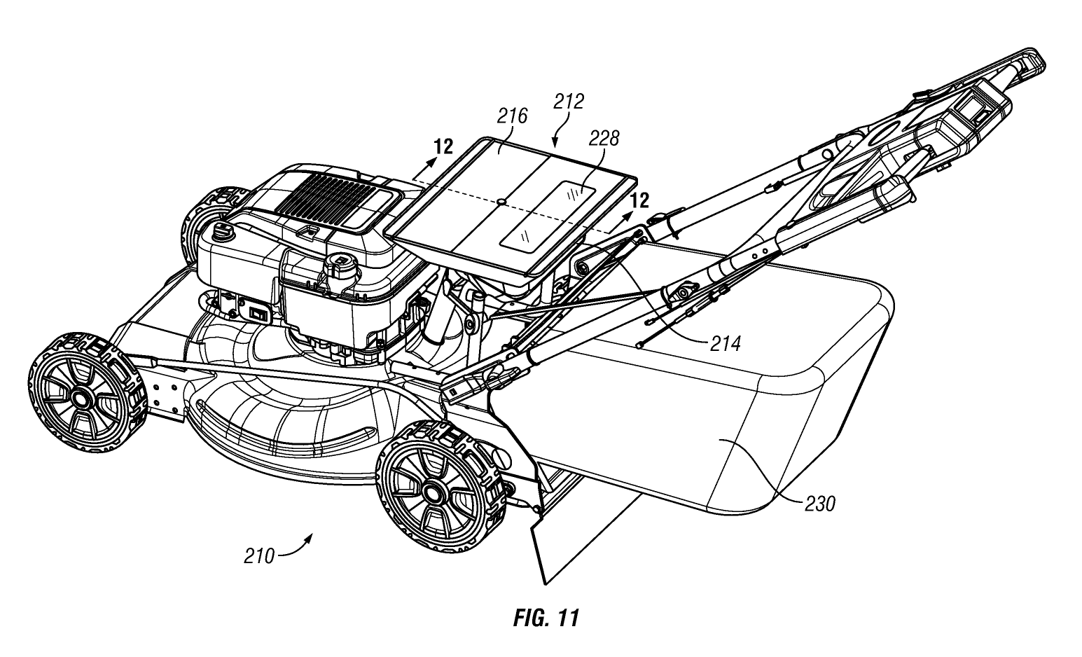

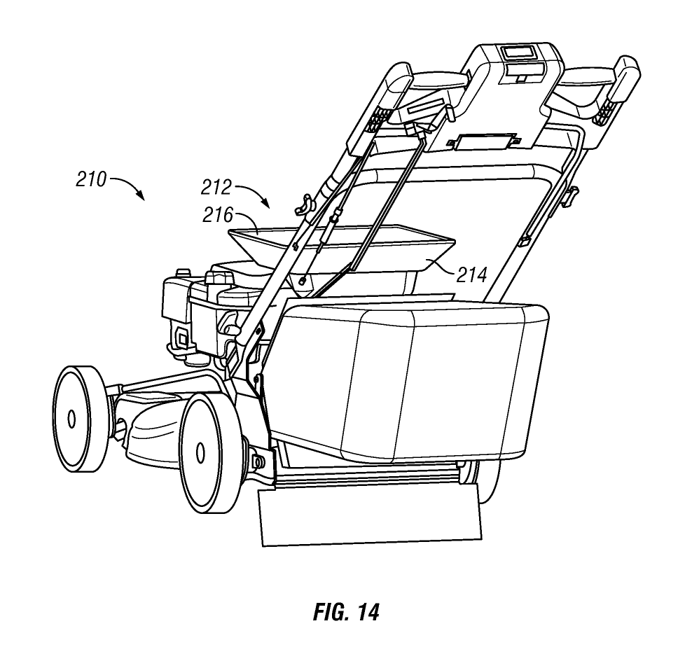

In other embodiments, the hopper 126 is not coupled to a fill bag. Instead, contents may be poured directly into the hopper 126 or into a storage container (e.g., bucket) connected to the hopper 126 (see generally FIGS. 10-15). The storage container may have rigid or flexible walls. The storage container may further include a lid or cover that, when opened, allows for filling of the storage container, and when closed (e.g., latched, locked), encloses the contents. In some embodiments, the storage container further includes a transparent or translucent portion (e.g., window) that allows an operator to view the level or amount contents within the storage container without opening the lid (see, e.g., window 228 as shown in FIG. 10). The transparent or translucent portion may be on the top of the storage container as shown in FIG. 10, along a side of a storage container, include the whole structure of the storage container (e.g., clear plastic storage container), or may be otherwise positioned.

Referring to FIGS. 5-6, the spreader 124 includes the conduit 130 (e.g., discharge chute), which connects to the hopper 126. According to an exemplary embodiment, the conduit 130 connects the hopper 126 to an opening in the mowing deck 118 of the lawn mower 110, such as the outlet 132 as shown in FIG. 6. In some embodiments, instead of providing the shortest path from the hopper to the cutting chamber, the conduit 130 extends diagonally forward and downward from the hopper 126 toward the center of the deck 118.

According to an exemplary embodiment, the outlet 132 of the conduit 130 is located proximate to the center of the mowing deck 118, and the conduit 130 directs the contents of the spreader 124 above the area through which the blade 120 spins. In some embodiments, the cutting chamber formed by the deck 118 is generally dome-shaped and includes a narrower dome or protrusion extending upward from the center of the top of the mowing deck 118, upon which the engine 112 is attached (see FIGS. 2, 5, and 16). The narrower dome of the mowing deck 118 is positioned over a middle section of the blade 120. Applicants believe the location of the outlet 132 when formed in the narrower dome of the mowing deck 118 to be in a low-pressure area within the cutting chamber of the mowing deck 118 when the blade 120 is spinning As such, a vacuum pulls the contents from the conduit 130, helping to prevent blockages. In contemplated embodiments, the cutting chamber is generally round and the outlet 132 is located closer to the center of the cutting chamber than to the periphery of the cutting chamber. In some contemplated embodiments, the outlet 132 is located within one third of the radius of the cutting chamber from the center of the cutting chamber, where the vacuum draws the contents from the conduit 130.

In some embodiments, the outlet 132 of the conduit 130 from the hopper 126 may include a deflector to prevent grass clippings or other debris from flowing upward through or clogging the outlet 132.

In some embodiments, the contents of the spreader 124 are dropped directly onto the blade 120, and rotation of the blade 120 distributes the contents while also cutting the grass. However, depending upon the contents, the particular lawn mower design, and the environment of use (e.g., humidity and temperature), use of the blade 120 to distribute the contents may lead to clumping or uneven distribution of the contents. As such, according to an exemplary embodiment the spreader 124 further includes a spreading element 142 (FIG. 6) other than the blade 120, which is intended to distribute the contents of the spreader 124.

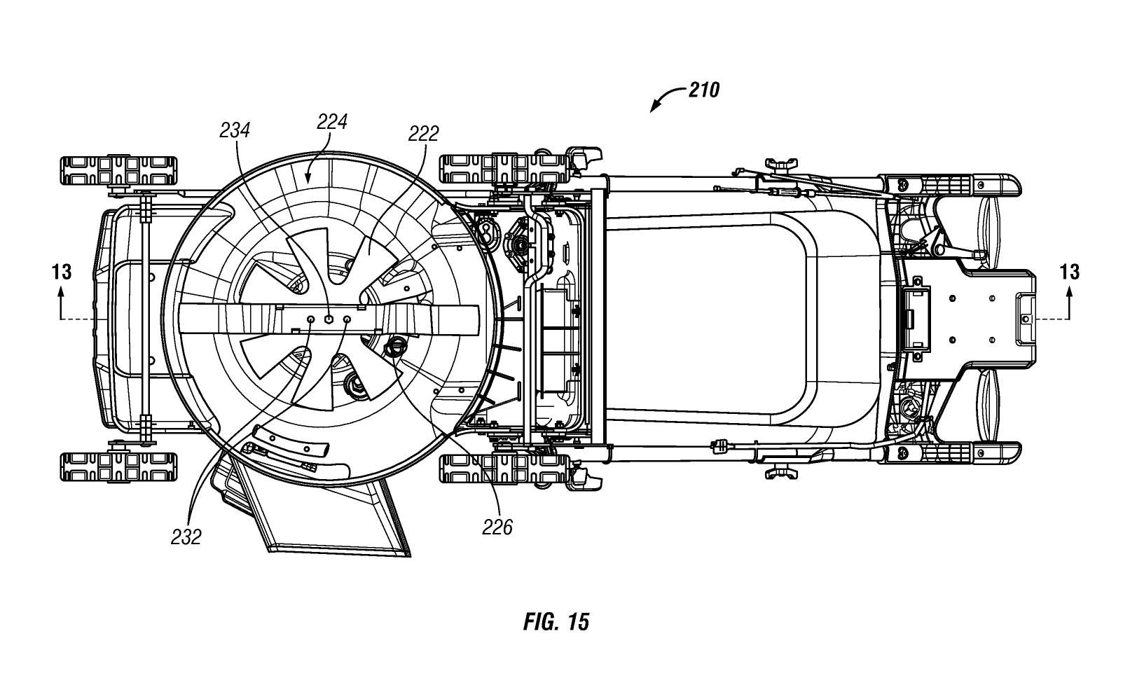

Referring to FIG. 6, the spreading element 142 spins and may be coupled to the power take-off of the engine 112 and/or to the blade 120. In some embodiments, the spreading element 142 is positioned between the engine 112 and the blade 120, and is symmetrically arranged to spin about the axis of rotation of the power take-off and/or blade 120. In some embodiments, blade fasteners 164 secure the blade 120 to a hub 146 of the spreading element 142, which includes an engine shaft bolt (see also hub bolt 234 and blade bolts 232 as shown in FIG. 15). In other contemplated embodiments, the spreading element is not aligned with the blade or power take-off, and is instead coupled to a pulley or chain-and-sprocket system that rotates the spreading element, and is powered by the drive train or power take-off.

In some embodiments, the spreading element 142 includes arms 144 laterally extending from the hub 146 (e.g., center, central portion). In some such embodiments, the arms 144 include flat surfaces and are horizontally level. According to an exemplary embodiment, the spreading element 142 is generally planar. Between the arms 144 are open areas 148 (e.g., open slots, completely open space). Referring to FIGS. 6 and 16, the open areas 148 are about the same size as the area of the arms 144 in the plane defined by the spreading element 142. According to an exemplary embodiment, spreading element is an integral slotted disk formed (e.g., stamped, cut, molded) from continuous material, and the open areas 148 extend from a periphery of the disk to the hub 166. The arms 144 are longer than half the radius of the disk in some embodiments. In some embodiments, the arms 144 widen with distance from the hub 146, as shown in FIGS. 6 and 16. The slotted-disk geometry of the spreader element 142 is believed to provide advantages over circular plates without slots and other shapes for reasons disclosed below, however in other embodiments circular plates without slots or other shapes may be used.

During operation of the spreader 124, contents of the spreader 124 are dropped through the outlet 132 of the conduit 130 and into the cutting chamber formed by the mowing deck 118. The contents are then distributed via contact with the spreading element 142 and/or blown by an air flow generated by the blade 120 and spreading element 142. The contents of the spreader 124 may contact internal surfaces of the mowing deck 118 (e.g., skirt), and be directed to the grass.

Applicants believe that the geometry of the spreading element 142, such as the ratio of surface area to open space of the spreading element 142, allows for granules, seeds, or pellets to roll off the horizontal top of the spreading element 142, instead of impacting the vertical sides of the arms 144 or the blade 120. As such, the granules, seeds, or pellets remain substantially intact during the process, which allows the granules, seeds, or pellets to function as intended (e.g., time-release, grow, etc.). Applicants have found that addition of the spreading element 142 shown in FIG. 6 does not substantially affect the cutting performance of the lawn mower 110, such as by providing significant drag, and also does not substantially increase the noise of the lawn mower 110.

Some other embodiments may use a plate without open areas 148 for a spreading element. However, Applicants have also found that use of the plate without open areas 148 results in collection of grass above the plate, which becomes compacted. But with the spreading element 142 having the open areas 148, Applicants have found that grass generally does not collect or become compacted.

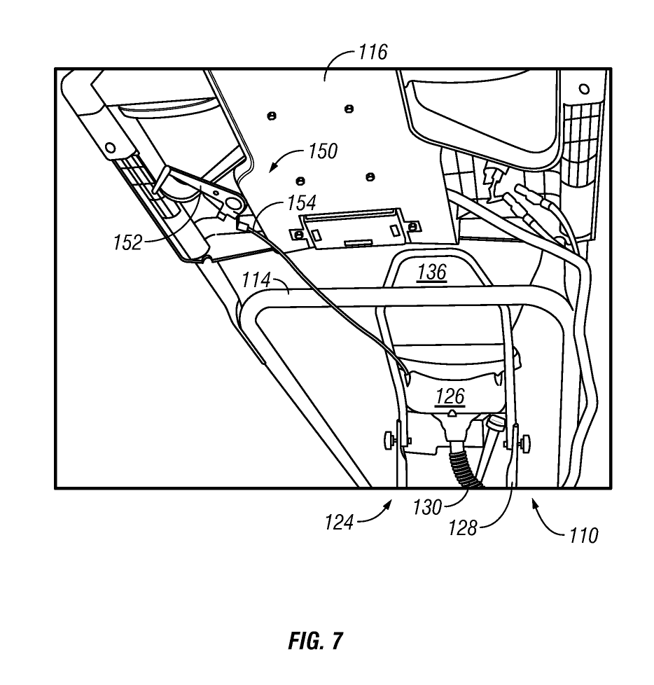

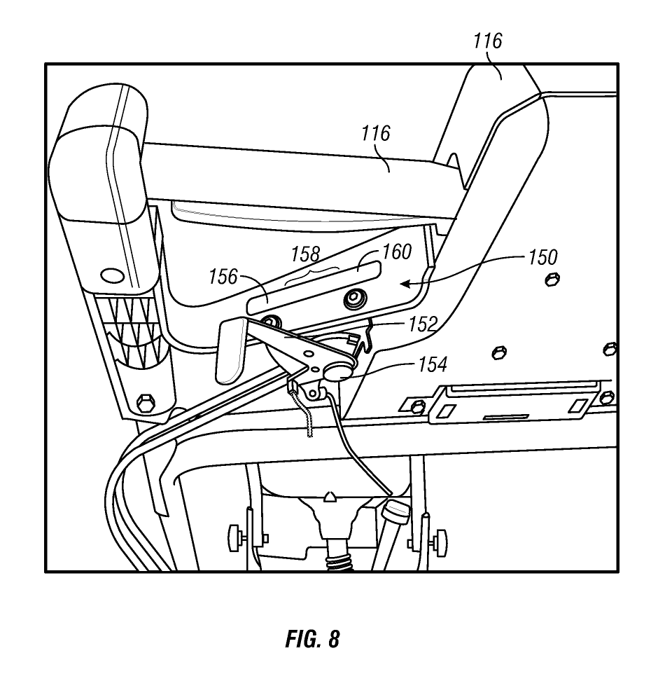

Referring to FIGS. 7-8, the spreader 124 includes a control system 150, which includes a controller 152 (e.g., interface, lever, button, knob, dial) that allows the operator to control the spreader 124 (e.g., to turn the spreader on or off). According to an exemplary embodiment, the controller 152 is coupled to the handle 116 of the lawn mower 110, and is accessible to the operator while the operator is walking behind the lawn mower 110. In some embodiments, the control system 150 is mechanical, and includes a mechanical linkage 154 (e.g., Bowden cable, rod) coupling the controller 152 to a valve, restrictor, or gate integrated with the spreader 124. According to an exemplary embodiment, the valve, restrictor, or gate may be located between the fill bag 138 and the hopper 126, within the hopper 126, between the hopper 126 and the conduit 130, along the conduit 130, or at the outlet 132. In other embodiments, the control system is electro-mechanical, and includes an interface that sends an electronic or radio-frequency signal to an actuator (e.g., solenoid, motor) that operates a valve, restrictor, or gate integrated with the spreader.

Referring to FIG. 8, the controller 152 is a lever that may be moved from an off position 156, along a spectrum 158 of increasing flow rate, to a fully open position 160, which corresponds to a maximum flow rate of contents from the spreader 124. According to an exemplary embodiment, the controller 152 may be held in a set position along the spectrum 158 by way of friction, notches, a latch, or other locking features.

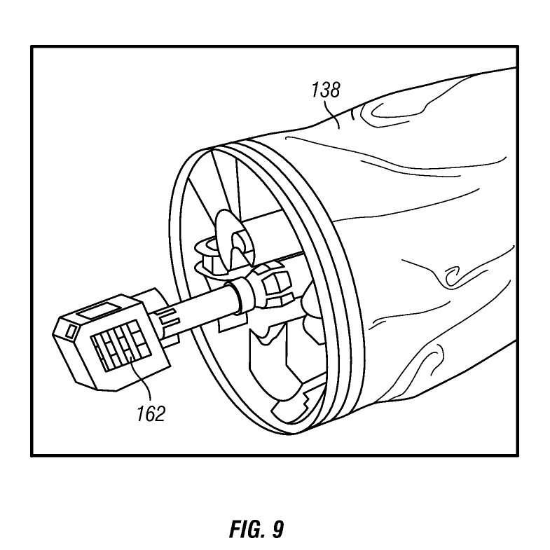

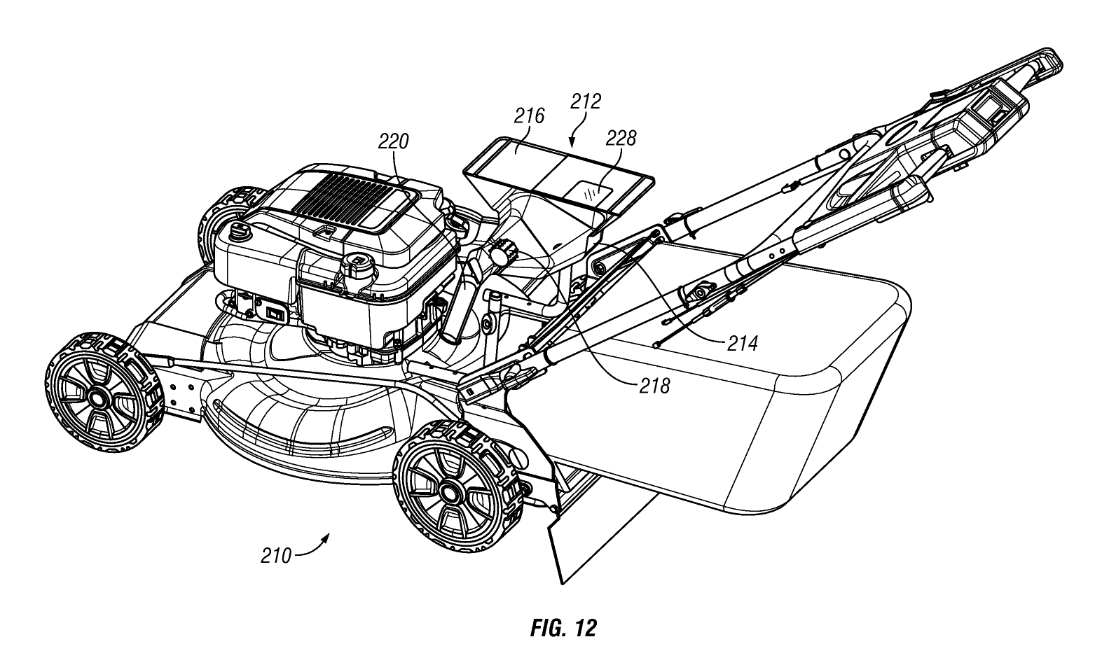

Referring now to FIG. 9, the spreader 124 may further include an actuator 162, such as a small electric motor. In some embodiments, the actuator 162 is located within the hopper 126 (FIG. 3). The actuator 162 may be coupled to an agitator (see agitator 218 as shown in FIG. 12) that moves (e.g., rotates) within the hopper 126 or within the fill bag 138. That actuator 162 may be controlled by a button (not shown) associated with the control system 150, may automatically run when the spreader 124 is operating, or may automatically run during portions of the operation of the spreader 124, such as when the spreader 124 is initially activated.

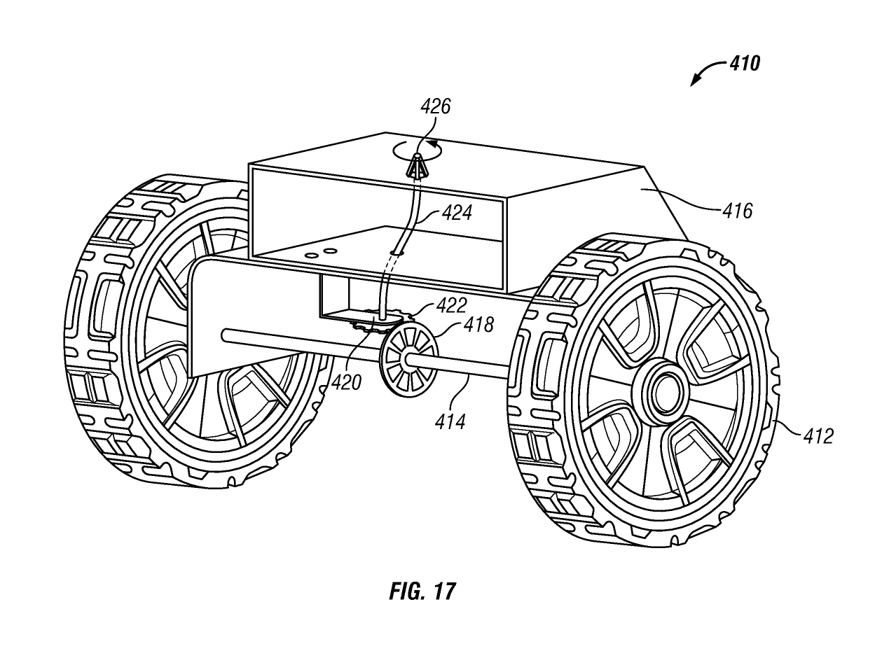

In other embodiments, an agitator of the spreader may be coupled to the drive train of the lawn mower or power take-off of the engine, in place of the actuator 162. Referring to FIG. 17, a drive system for outdoor power equipment 410 is coupled to a spreader that includes a rotary actuator 426 that connects with an internal auger of a drop-in fertilizer bag (see, e.g., bag 138 as shown in FIG. 1). Rotation of the axle 414 of the rear wheels 412 spins a first wheel 418 (e.g., gear, slotted disk) that drives second wheel 422 (e.g., pinion, gear) orthogonal to the first wheel 418 and supported by a bracket 420. The second wheel 422 drives the rotary actuator 426 via a mechanical linkage 424 (e.g., flexible drive cable) that passes through a base plate 416 of the outdoor power equipment 410.

In some embodiments, the spreader 124 (e.g., hopper 126) includes a vibrating plate (e.g., shaker) that helps to prevent or break up conglomerations or clumps of contents of the spreader 124.

According to a contemplated embodiment, a spreader includes a main hopper and a supplemental hopper. The main hopper may include first contents, such as fertilizer, to be spread over a large area. The supplemental hopper may include second contents, such as weed killer or marking paint, to be distributed to smaller or more-specific areas. The control system may include a first controller for operating the main hopper and a second controller for operating the supplemental hopper. Either or both of the controllers may allow for controlling the distribution location (e.g., targeting) of the contents. For example, the second controller may include a lever that allows for aiming of the second contents with a button for activating and deactivating flow of the second contents.

Referring now to FIGS. 10-15, a lawn mower 210 includes a spreader 212. The spreader 212 includes a hopper 214, which is designed to receive fertilizer granules through a cover 216. Within the hopper 214, the spreader includes an agitator 218 (FIG. 12), which rotates about the transverse axis of the lawn mower 210. In some embodiments, the agitator 218 includes a cylindrical core (e.g., barrel) with protrusions extending from the core. Rotation of the agitator 218 breaks apart clumps of fertilizer granules by crushing the clumps between the agitator 218 and walls of the hopper 214, and additionally moves the fertilizer granules to a chute 220. From the chute 220, the granules are delivered to a spreading element 222 (e.g., slotted disk) (FIG. 15) via a port 226 within a cutting chamber 224 of the lawn mower 210, for distribution. FIG. 16 shows a cutting chamber 310, blade 312, and spreading element 314 according to another exemplary embodiment.

The construction and arrangements of the lawn mower and spreader system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A lawn mower and spreader system, comprising:
a deck supporting an engine having a power takeoff, wherein the deck at least partially surrounds a blade coupled to the power takeoff;
a hopper configured to support granular fertilizer, wherein the hopper has a discharge chute leading to an opening in the deck; and
a spreading element coupled to the power takeoff and positioned between the deck and the blade, wherein the spreading element comprises:
a hub; and
arms that extend laterally from hub, wherein the arms are spaced apart from one another by open slots.

2. The system of claim 1, wherein the arms are flat.

3. The system of claim 2, wherein the arms are level with respect to one another.

4. The system of claim 1, wherein the spreading element is planar.

5. The system of claim 4, wherein the width of the arms increases with distance from the hub.

6. The system of claim 5, wherein the area of the open slots in the plane is about the same as the area of the arms in the plane.

7. The system of claim 1, wherein the spreading element is an integral slotted disk of continuous material.

8. The system of claim 7, wherein the open slots extend from the hub to the periphery of the slotted disk, and wherein the arms are only coupled to one another via the hub.

9. The system of claim 7, wherein the open slots extend inward from the periphery of the slotted disk by a distance greater than half of the radius of the disk.

10. A lawn mower and spreader system, comprising:
a deck having a skirt and a top, which together form a cutting chamber at least partially surrounding a blade, wherein the top of the deck supports an engine having a power takeoff extending through the top of the deck and coupled to the blade;
front and rear wheels coupled to the deck;
a spreading element coupled to the power takeoff and positioned between the deck and the blade;
a hopper positioned generally over the rear wheels and configured to support granular fertilizer, wherein the hopper has a discharge chute leading to an opening in the deck that is positioned over the spreading element.

11. The system of claim 10, wherein the cutting chamber is generally dome-shaped and further includes a narrower dome protruding from the generally dome-shaped cutting chamber over a middle section of the blade, whereby rotation of the blade forms a low pressure in the narrower dome, and wherein the opening in the deck for the discharge chute of the hopper is formed in the narrower dome such that the low pressure draws fertilizer through the chute when the blade is rotating.

12. The system of claim 10, wherein the opening in the deck for the discharge chute of the hopper is closer to the center of the top of the deck than to the skirt.

13. A lawn mower and spreader system, comprising:
a deck supporting an engine having a power takeoff, wherein the deck at least partially surrounds a blade coupled to the power takeoff;
a spreading element coupled to the power takeoff and positioned between the deck and the blade;
a hopper comprising a discharge chute leading to an opening in the deck that is positioned over the spreading element; and
a frame supporting the hopper, wherein the frame is fastened to the deck and comprises a joint configured to allow the hopper to rotate forward and rearward with respect to the deck.

14. The system of claim 13, further comprising front and rear wheels coupled to the deck, wherein the frame is fastened to the deck such that the hopper is positioned generally over the rear wheels.

15. The system of claim 14, further comprising:
an agitator configured to interact with contents of the hopper;
a mechanical linkage between the agitator and an axle of at least one of the front and rear wheels, wherein the mechanical linkage communicates rotation of the axle to the agitator.

16. The system of claim 13, wherein the hopper further comprises a translucent viewing window configured to allow an operator to view contents of the hopper.

17. The system of claim 16, wherein the viewing window is positioned on a top surface of the hopper.

18. The system of claim 13, wherein the hopper further comprises:
a receiver configured to support a drop-in bag of granular fertilizer; and
a connector configured to couple the drop-in bag to the discharge chute.

19. The system of claim 18, further comprising a support surface extending generally diagonally upward and rearward from the receiver, wherein the support surface is configured to at least partially support the drop-in bag.

20. The system of claim 19, further comprising a drop-in bag of granular fertilizer.
